(19) United States
(12) Patent Application Publication
(10) Pub. No.: US 2026/0202569 A1
(43) Pub. Date: Jul. 16, 2026

(54) EVENT DETECTION AND CLASSIFICATION USING DISTRIBUTED ACOUSTIC SENSING (DAS) IN HYDROCARBON WELLS USING DEEP-LEARNING ALGORITHMS

(71) Applicant: BP Corporation North America Inc., Houston, TX (US)

(72) Inventors: Adesh PANDEY, Golden, CO (US); Iga Pawelec, Krakow (PL); Xiaolei Song, Houston, TX (US); Muhong Zhou, Houston, TX (US)

(73) Assignee: BP Corporation North America Inc., Houston, TX (US)

(21) Appl. No.: 19/445,489

(22) Filed: Jan. 10, 2026

Related U.S. Application Data
(60) Provisional application No. 63/745,449, filed on Jan. 15, 2025.

(51) Int. Cl. G01V 1/50; E21B 47/002; G01V 1/22; G06T 7/00; G06V 10/764; G06V 10/774; G06V 10/776; G06V 10/82

(52) U.S. Cl. CPC G01V 1/50; E21B 47/002; G01V 1/226; G06T 7/0002; G06V 10/764; G06V 10/82; E21B 2200/20; E21B 2200/22; G01V 2210/74; G06T 2207/20081; G06T 2207/20084; G06T 2207/30181; G06V 10/774; G06V 10/776

(57) ABSTRACT

A method of detecting an event within a wellbore includes obtaining a sample data set, forming an image using the fiber optic-based signal, using the image as an input to an anomaly detection model, detecting an anomaly within the image with the anomaly detection model, and outputting an indication of the anomaly. The sample data set is a sample of fiber optic-based signal originating within a wellbore, and the sample data set is representative of the fiber optic-based signal across a depth section of the wellbore over a time period.

### CROSS-REFERENCE TO RELATED APPLICATIONS

The present application claims priority to U.S. Provisional Application No. 63/745,449 filed on Jan. 15, 2025, and entitled “EVENT DETECTION AND CLASSIFICATION USING DISTRIBUTED ACOUSTIC SENSING (DAS) IN HYDROCARBON WELLS USING DEEP-LEARNING ALGORITHMS,” which is hereby incorporated herein by reference in its entirety for all purposes.

### BACKGROUND

Within a hydrocarbon production well, various events can occur that produce acoustic signals. For example, fluids such as hydrocarbons, water, gas, and the like can be produced from the formation into the wellbore. The production of the fluid can result in the movement of the fluids in various downhole regions, including within the subterranean formation, from the formation into the wellbore, and within the wellbore itself. Efforts have been made to detect events such as fluid movement.

### BRIEF SUMMARY OF THE DISCLOSURE

In some embodiments, a method of detecting an event within a wellbore comprises: obtaining a sample data set, forming an image using the fiber optic-based signal, using the image as an input to an anomaly detection model, detecting an anomaly within the image with the anomaly detection model, and outputting an indication of the anomaly. The sample data set is a sample of fiber optic-based signal originating within a wellbore, and the sample data set is representative of the fiber optic-based signal across a depth section of the wellbore over a time period.

In some embodiments, a system for detecting an event within a wellbore comprises: a processor, and a memory storing a plurality of models. The plurality of models, when executed on the processor, configures the processor to: obtain a sample data set from a fiber optic sensor, form an image using the fiber optic-based signal, use the image as an input to an anomaly detection model, detect an anomaly within the image with the anomaly detection model, and output an indication of the anomaly to a display device. The sample data set is a sample of fiber optic-based signal originating within a wellbore, and the sample data set is representative of the fiber optic-based signal across a depth section of the wellbore over a time period.

In some embodiments, a method of detecting an event within a wellbore comprises: obtaining a sample data set from a fiber optic sensor disposed in a wellbore, forming an image using the fiber optic-based signal, using the image as an input to an anomaly detection model, detecting an anomaly within the image with the anomaly detection model, forming a second image from the sample data set, applying the second image to an event detection model, detecting an event in the second image using the event detection model, and outputting an indication of the event. The sample data set is a sample of fiber optic-based signal, and the sample data set is representative of the fiber optic-based signal across a depth section of the wellbore over a time period. The anomaly detection model comprises a deep-learning algorithm, and the event detection model comprises a convolutional neural network (CNN).

These and other features will be more clearly understood from the following detailed description taken in conjunction with the accompanying drawings and claims.

Embodiments described herein comprise a combination of features and advantages intended to address various shortcomings associated with certain prior devices, systems, and methods. The foregoing has outlined rather broadly the features and technical advantages of the invention in order that the detailed description of the invention that follows may be better understood. The various characteristics described above, as well as other features, will be readily apparent to those skilled in the art upon reading the following detailed description, and by referring to the accompanying drawings. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a schematic illustration of a process for detecting an anomaly or event according to some embodiments.

FIG. 2 is another schematic illustration of a process for detecting an anomaly or event according to some embodiments.

FIG. 3 is a schematic, cross-sectional illustration of a downhole wellbore environment according to an embodiment.

FIG. 4 is a schematic illustration of a system for processing fiber optic-based signals according to some embodiments.

FIG. 5 is a schematic illustration of the architecture for a U-Net neural network according to some embodiments.

FIG. 6 is a schematic illustration of a system for training a neural network according to some embodiments.

FIG. 7 is a schematic illustration of a process for training a neural network according to some embodiments.

FIG. 8 is a schematic illustration of an architecture for a convolutional neural network according to some embodiments.

FIG. 9 schematically illustrates a computer that can be used to carry out various steps according to an embodiment.

FIG. 10 schematically illustrates another computer that can be used to carry out various steps according to an embodiment.

### DETAILED DESCRIPTION OF THE PREFERRED EMBODIMENTS

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . ”. Reference to up or down will be made for purposes of description with “up,” “upper,” “upward,” “upstream,” or “above” meaning toward the surface of the wellbore and with “down,” “lower,” “downward,” “downstream,” or “below” meaning toward the terminal end of the well, regardless of the wellbore orientation. Reference to inner or outer will be made for purposes of description with “in,” “inner,” or “inward” meaning towards the central longitudinal axis of the wellbore and/or wellbore tubular, and “out,” “outer,” or “outward” meaning towards the wellbore wall. As used herein, the term “longitudinal” or “longitudinally” refers to an axis substantially aligned with the central axis of the wellbore tubular, and “radial” or “radially” refer to a direction perpendicular to the longitudinal axis. The various characteristics mentioned above, as well as other features and characteristics described in more detail below, will be readily apparent to those skilled in the art with the aid of this disclosure upon reading the following detailed description of the embodiments, and by referring to the accompanying drawings.

Disclosed herein is a new real time signal processing architecture that allows for the identification of various downhole events in real time or near real time. Various events can be detected such as gas influx detection, downhole leak detection, well-barrier integrity monitoring, fluid inflow, and the identification of in-well sand ingress zones. As used herein, the term “real time” refers to a time that it takes into account various communication and latency delays within a system, and can include actions taken within about ten seconds, within about thirty seconds, within about a minute, within about five minutes, or within about ten minutes of the action occurring. Various sensors (e.g., distributed fiber optic-based sensors such as acoustic sensors, temperature sensors, etc.) can be used to obtain a fiber optic distributed sensing signal such as an acoustic data sample and/or temperature data sample at various points along the wellbore. The fiber optic-based data sample can then be processed using signal processing architecture to obtain an acoustic signal of interest that can then be used to form an image for further image processing. When an anomaly is detected using the image, the selected data can be further processed to identify an event. The signal processing techniques described herein can also help to address the big-data problem through intelligent extraction of data (rather than crude decimation techniques) using anomaly detection followed by event identification to considerably reduce real time data volumes being processed using processor intensive event detection models.

In some aspects, the fiber optic sensing signal can comprise an acoustic signal. The acoustic signal can be registered such that the entire wellbore or a portion of interest is acquired. Fiber optic distributed acoustic sensors (DAS) capture acoustic signals resulting from downhole events such as wellbore integrity events, tubing or casing leaks, flow behind casing, microseismic events, wellbore operating events (e.g., sleeve movements, choke movements, choke ramp-ups, etc.), gas influx, fluid flow past restrictions, sand ingress, and the like as well as other background acoustics including active source signals (e.g., pumps, surface equipment, seismic surveys, etc.). The resulting acoustic signal can be used to obtain an image of the acoustics in the wellbore over a selected time period to allow for image processing techniques to be used to identify anomalies and/or events.

The ability to identify various events in the wellbore may allow for various actions to be taken (remediation procedures) in response to the events. For example, a well can be shut in, production can be increased or decreased, and/or remedial measures can be taken in the wellbore, as appropriate based on the identified event(s).

As described herein, any suitable acoustic signal indicators that can be used to form an image can be used in the anomaly and/or event detection. In some aspects, fiber optic sensor based outputs such as acoustic power, acoustic intensity, or the like can be used as the basis for the anomaly and/or event detection. In some aspects, one or more features can be derived from the acoustic signal and used with DAS acoustic data processing in real time to provide inputs to the anomaly and/or event detection. Various types of features can be used with the processing methods and systems as disclosed herein to detect the anomalies and events.

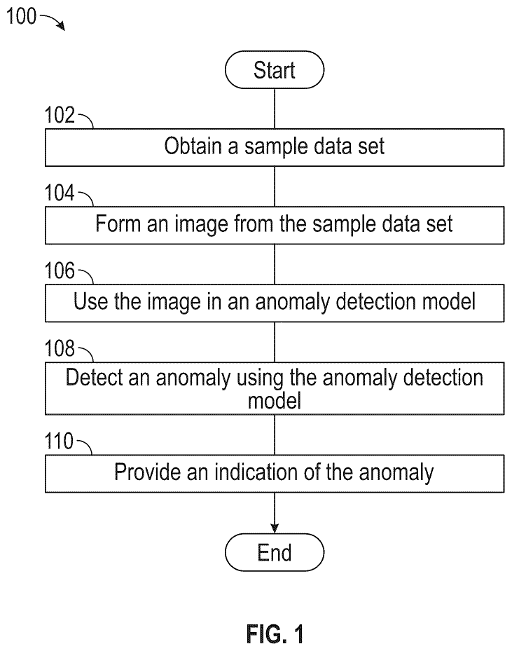

Referring to FIG. 1, a process 100 for detecting an event within a wellbore is schematically illustrated. As shown the process can begin by obtaining or receiving a sample data set at step 102. The sample data set can comprise fiber optic-based data from a fiber optic sensor disposed in a wellbore. The fiber optic data can comprise any suitable fiber optic data such as DAS data, distributed temperature sensing (DTS) data, or the like. The fiber optic-based data can generally comprise data across a depth section of the wellbore taken over a defined time period.

Once the sample data set is obtained, an image can be formed using the sample data set at step 104. The image can be a representation of the fiber optic-based data values presented as a depth versus time image. As described in more detail herein, the values (e.g., pixels within the image) within the image can represent raw fiber optic-based data such as acoustic power or intensity, and/or the values can represent one or more features extracted or obtained from the fiber optic-based data.

In addition, various optional pre-processing steps can be used with the fiber optic based data and/or the image prior to providing the image to an anomaly detection model. For example, various noise reduction techniques and/or normalization techniques (e.g., robust normalization, etc.) can be used to process the data and/or image prior to using the anomaly detection model.

The image can then be used with image processing techniques to identify the presences of an anomaly. In some aspects, the image can be used as an input to an anomaly detection model in step 106. As described in more detail herein, any suitable model can be used to identify the anomaly within the image, and in some aspects, a deep learning model can be used with the image. In some aspects, the deep learning model can comprise a U-net neural network.

At step 108, the anomaly detection model can be used to detect an anomaly. The specific detection technique can depend on the type of anomaly detection model used. In some aspects, when the anomaly detection model comprises a deep-learning model, the detection process can comprise applying the image to the neural network (e.g., a U-Net neural network), converting the image to an output image, comparing the image to the output image, determining a loss parameter based on the comparing, and determining, when the loss parameter exceeds a threshold, that an anomaly is present in the image.

Once detected, an output or indication of the anomaly can be provided at step 110. In some aspects, the detection of an anomaly, which can represent the presence of an event relative to a background signal without an event, can be considered the detection of an event. In some aspects, the process 100 may end with the detection and identification of the anomaly at step 110, or the method can proceed to pass the fiber optic-based data having an anomaly identified therein to an event detection and/or classification process. In some aspects, any fiber optic-based data associated with an identified anomaly can be saved for further processing.

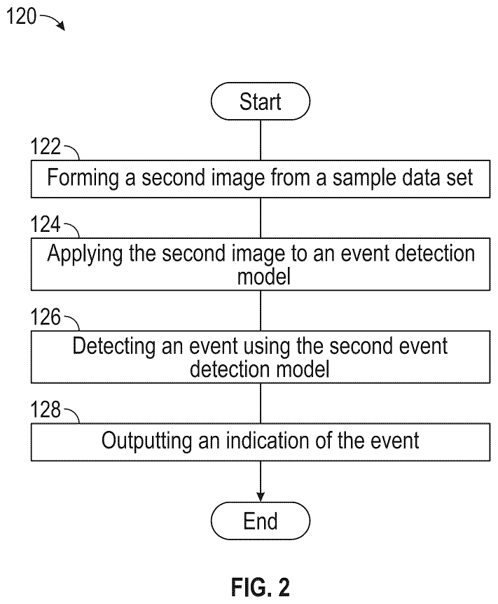

Referring to FIG. 2, a process 120 for detecting and/or identifying an event (e.g., a specific event) within a wellbore is schematically illustrated. The process 120 can begin or be triggered based on the detection of an anomaly. For example, an anomaly can be detected within an image formed from fiber optic-based data as provided in the process 100 of FIG. 1, or the detection of an anomaly using another other sensors or data available from the wellbore or surface equipment associated with the wellbore. In some aspects, the process 120 can be performed without an initial detection of an anomaly in any fiber optic-based data, and the process 120 can be used to try to identify an anomaly and/or event within fiber optic-based data from the wellbore.

The process 120 can begin by forming an image from a sample data set at step 122. The sample data set can be obtained from a fiber optic-based signal from the wellbore, and the sample data set can be the same as or different from the sample-based data set used to identify an anomaly (if anomaly detection is performed first). An image can then be formed from the fiber optic-based data, which can be the same image used for anomaly detection (if performed) or a different image. For example, different types of features can be used to form the image, where the features can be based on or derived from the fiber optic-based data. Exemplary features can include, but are not limited to, acoustic power, acoustic intensity, a feature derived from the frequency domain, a feature derived from the time domain, any derivation thereof, or any combination thereof.

The second image can be applied to an event detection model at step 124. The event detection model can be any suitable model that can perform image processing and/or image recognition. In some aspects, the event detection model can comprise a convolutional neural network (CNN) such as a residual net CNN, as described in more detail herein. The output of the model can provide a classification or indication of the type of event using the second image at step 126.

An output or indication can then be provided to indicate the specific event identified using the event detection model at step 128. The event detection model can be trained to identify various types of events. Exemplary events include, but are not limited to, a wellbore integrity event, a tubing or casing leak, flow behind casing, a microseismic event, a wellbore operating event, gas influx, fluid flow past a restriction, a seismic shot, a slug movement, sand ingress, a weak anomaly event, a strong anomaly event, or any combination thereof. Various additional processing and remediation steps can be taken based on the detection and identification of a specific event.

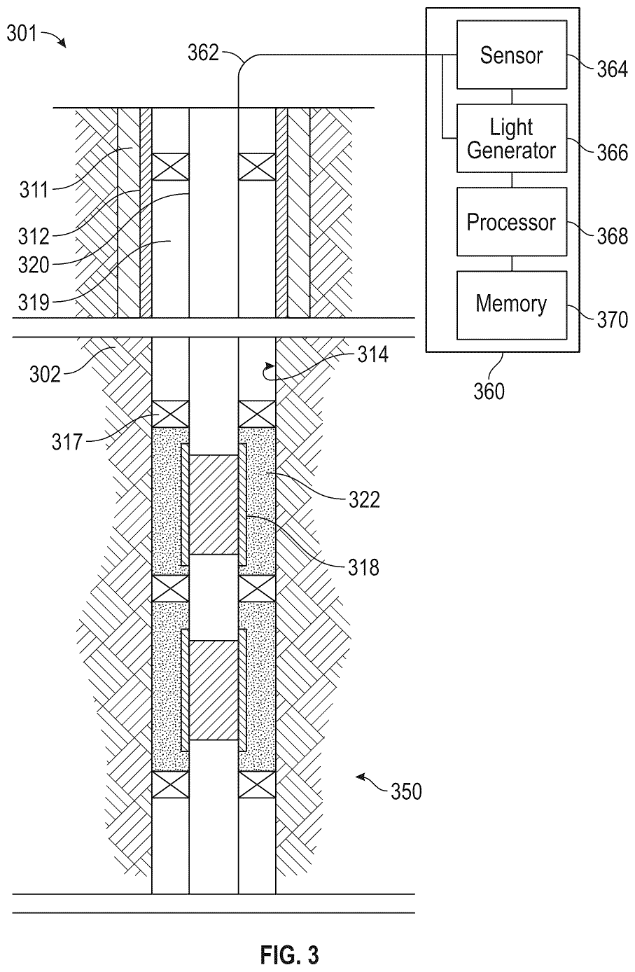

Having described the anomaly and event detection processes generally, the specific process steps and associated systems will now be described in more detail. Referring now to FIG. 3, an example of a wellbore operating environment 301 is shown. As will be described in more detail below, embodiments of completion assemblies comprising distributed acoustic sensor (DAS) system in accordance with the principles described herein can be positioned in environment 301.

As shown in FIG. 3, exemplary environment 301 includes a wellbore 314 traversing a subterranean formation 302, casing 312 lining at least a portion of wellbore 314, and a tubular 320 extending through wellbore 314 and casing 312. A plurality of spaced screen elements or assemblies 318 are provided along tubular 320. In addition, a plurality of spaced zonal isolation device 317 and gravel packs 322 are provided between tubular 320 and the sidewall of wellbore 314. In some embodiments, the operating environment 301 includes a workover and/or drilling rig positioned at the surface and extending over the wellbore 314.

In general, the wellbore 314 can be drilled into the subterranean formation 302 using any suitable drilling technique. The wellbore 314 can extend substantially vertically from the earth's surface over a vertical wellbore portion, deviate from vertical relative to the earth's surface over a deviated wellbore portion, and/or transition to a horizontal wellbore portion. In general, all or portions of a wellbore may be vertical, deviated at any suitable angle, horizontal, and/or curved. In addition, the wellbore 314 can be a new wellbore, an existing wellbore, a straight wellbore, an extended reach wellbore, a sidetracked wellbore, a multi-lateral wellbore, and other types of wellbores for drilling and completing one or more production zones. As illustrated, the wellbore 314 includes a substantially vertical producing section 350, which is an open hole completion (i.e., casing 312 does not extend through producing section 350). Although section 350 is illustrated as a vertical and open hole portion of wellbore 314 in FIG. 3, embodiments disclosed herein can be employed in sections of wellbores having any orientation, and in open or cased sections of wellbores. The casing 312 extends into the wellbore 314 from the surface and is cemented within the wellbore 314 with cement 311.

Tubular 320 can be lowered into wellbore 314 for performing an operation such as drilling, completion, workover, treatment, and/or production processes. In the embodiment shown in FIG. 3, the tubular 320 is a completion assembly string including a fiber optic sensor such as a DAS sensor coupled thereto. However, in general, embodiments of the tubular 320 can function as a different type of structure in a wellbore including, without limitation, as a drill string, casing, liner, jointed tubing, and/or coiled tubing. Further, the tubular 320 may operate in any portion of the wellbore 314 (e.g., vertical, deviated, horizontal, and/or curved section of wellbore 314). Embodiments of a fiber optic based sensing systems described herein can be coupled to the exterior of the tubular 320, or in some embodiments, disposed within an interior of the tubular 320. When the fiber optic cable is coupled to the exterior of the tubular 320, the fiber optic cable can be positioned within a control line, control channel, or recess in the tubular 320. In some embodiments, a sand control system can include an outer shroud to contain the tubular 320 and protect the system during installation. A control line or channel can be formed in the shroud and the fiber optic cable can be placed in the control line or channel.

The tubular 320 extends from the surface to the producing zones and generally provides a conduit for fluids to travel from the formation 302 to the surface. A completion assembly including the tubular 320 can include a variety of other equipment or downhole tools to facilitate the production of the formation fluids from the production zones. For example, zonal isolation devices 317 are used to isolate the various zones within the wellbore 314. In this embodiment, each zonal isolation device 317 can be a packer (e.g., production packer, gravel pack packer, frac-pac packer, etc.). The zonal isolation devices 317 can be positioned between the screen assemblies 318, for example, to isolate different gravel pack zones or intervals along the wellbore 314 from each other. In general, the space between each pair of adjacent zonal isolation devices 317 defines a production interval.

The screen assemblies 318 provide sand control capability. In particular, the sand control screen elements 318, or other filter media associated with wellbore tubular 320, can be designed to allow fluids to flow therethrough but restrict and/or prevent particulate matter of sufficient size from flowing therethrough. The screen assemblies 318 can be of the type known as “wire-wrapped”, which are made up of a wire closely wrapped helically about a wellbore tubular, with a spacing between the wire wraps being chosen to allow fluid flow through the filter media while keeping particulates that are greater than a selected size from passing between the wire wraps. Other types of filter media can also be provided along the tubular 320 and can include any type of structures commonly used in gravel pack well completions, which permit the flow of fluids through the filter or screen while restricting and/or blocking the flow of particulates (e.g. other commercially-available screens, slotted or perforated liners or pipes; sintered-metal screens; sintered-sized, mesh screens; screened pipes; prepacked screens and/or liners; or combinations thereof). A protective outer shroud having a plurality of perforations therethrough may be positioned around the exterior of any such filter medium.

The gravel packs 322 are formed in the annulus 319 between the screen elements 318 (or tubular 320) and the sidewall of the wellbore 314 in an open hole completion. In general, the gravel packs 322 comprise relatively coarse granular material placed in the annulus to form a rough screen against the ingress of sand into the wellbore while also supporting the wellbore wall. The gravel pack 322 is optional and may not be present in all completions.

The fluid flowing into the tubular 320 may comprise more than one fluid component. Typical components include natural gas, oil, water, steam, and/or carbon dioxide. The relative proportions of these components can vary over time based on conditions within the formation 302 and the wellbore 314. Likewise, the composition of the fluid flowing into the tubular 320 sections throughout the length of the entire production string can vary significantly from section to section at any given time.

In FIG. 3, the fiber optic monitoring system such as the fiber optic based sensing system can comprise an optical fiber 362 based acoustic sensing system that uses the optical backscatter component of light injected into the optical fiber for detecting acoustic perturbations (e.g., dynamic strain) along the length of the fiber 362. The light can be generated by a light generator or source 366 such as a laser, which can generate light pulses. The optical fiber 362 acts as the sensor element with no additional transducers in the optical path, and measurements can be taken along the length of the entire optical fiber 362. The measurements can then be detected by an optical receiver such as sensor 364 and selectively filtered to obtain measurements from a given depth point or range, thereby providing for a distributed measurement that has selective data for a plurality of zones along the optical fiber 362 at any given time. In this manner, the optical fiber 362 effectively functions as a distributed array of sensors (e.g., microphones for a DAS system, temperature sensors for a DTS system, etc.) spread over the entire length of the optical fiber 362, which can span any portion of the wellbore such as at least a portion of the production zone 350, a portion of the upper completion, or any combination thereof to detect downhole acoustics.

The light reflected back up the optical fiber 362 as a result of the backscatter can travel back to the source, where the signal can be collected by a sensor 364 and processed (e.g., using a processor 368). In general, the time the light takes to return to the collection point is proportional to the distance traveled along the optical fiber 362. The resulting backscattered light arising along the length of the optical fiber 362 can be used to characterize the environment around the optical fiber 362. The use of a controlled light source 366 (e.g., having a controlled spectral width and frequency) may allow the backscatter to be collected and any disturbances along the length of the optical fiber 362 to be analyzed. In general, any acoustic or dynamic strain disturbances along the length of the optical fiber 362 can result in a change in the properties of the backscattered light, allowing for a distributed measurement of both the acoustic magnitude, frequency and in some cases of the relative phase of the disturbance.

An acquisition device 360 can be coupled to one end of the optical fiber 362. As discussed herein, the light source 366 can generate the light (e.g., one or more light pulses), and the sensor 364 can collect and analyze the backscattered light returning up the optical fiber 362. In some contexts, the acquisition device 360 including the light source 366 and the sensor 364 can be referred to as an interrogator. In addition to the light source 366 and the sensor 364, the acquisition device 360 generally comprises a processor 368 in signal communication with the sensor 364 to perform various analysis steps described in more detail herein. While shown as being within the acquisition device 360, the processor can also be located outside of the acquisition device 360 including being located remotely from the acquisition device 360. The sensor 364 can be used to obtain data at various rates and may obtain data at a sufficient rate to detect the acoustic signals of interest with sufficient bandwidth. In an embodiment, depth or spatial (e.g., length along the axial direction of the fiber) resolution ranges of between about 1 meter and about 10 meters can be achieved. The measurements can be resolved into the identifiable depth sections of the optical fiber, which can be referred to in some contexts as channels. Each individual channel can provide an indication of the measurement such as an acoustic signal for a DAS system or a temperature signal for a distributed temperature sensing (DTS) system. Collectively, the resulting signals can produce a profile of the resulting sensor signals along a desired depth range of the wellbore with the optical fiber in place.

While the system described herein can be used with a DAS system to acquire an acoustic signal for a location or depth range in the wellbore 314, in general, any suitable fiber optic-based signal acquisition system can be used with the processing steps disclosed herein. For example, a DTS system operates similarly to a DAS based system but can produce temperature measurements within the channels to provide a temperature profile along at least a portion of the wellbore. Other fiber optic-based systems such as fiber optic-based pressure sensing systems can also be used. The benefit of the use of a fiber optic-based system is that the signal can be obtained across a plurality of locations and/or across a continuous length of the wellbore 314 rather than at discrete locations.

Referring to FIG. 3, the processor 368 within the acquisition device 360 can be configured to perform various data processing to provide a signal useable in a learning algorithm for anomaly detection and/or event detection. In some aspects, the acquisition device 360 may provide an output to a separate processor or computer that can provide a signal useable in a learning algorithm for anomaly detection and/or event detection. The acquisition device 360 can comprise a memory 370 configured to store an application or program to perform the data analysis. While shown as being contained within the acquisition device 360, the memory 370 can comprise one or more memories, any of which can be external to the acquisition device 360. In an embodiment, the processor 368 can execute the program, which can configure the processor 368 to filter the acoustic data set spatially, pre-process the signal (e.g., normalization, image interpolation, etc.), and provide the pre-processed signal to the corresponding learning model.

When the acoustic sensor comprises a DAS or DTS system, the optical fiber 362 can return raw optical data in real time or near real time to the acquisition unit 360. The intensity of the raw optical data is proportional to the acoustic intensity of the sound being measured. In an embodiment, the raw data can be stored in the memory 370 or database for various subsequent uses. The sensor 364 can be configured to convert the raw optical data into an acoustic data set. Depending on the type of DAS or DTS system employed, the optical data may or may not be phase coherent and may be pre-processed to improve the signal quality (e.g., for opto-electronic noise normalization/de-trending single point-reflection noise removal through the use of median filtering techniques or even through the use of spatial moving average computations with averaging windows set to the spatial resolution of the acquisition unit, etc.).

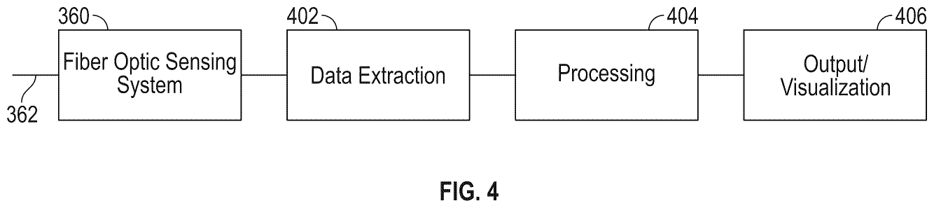

As shown schematically in FIG. 4, an embodiment of a system for detecting events can comprise a data extraction unit 402, a processing unit 404, and/or an output or visualization unit 406. The data extraction unit 402 can obtain the optical data and perform the initial pre-processing steps to obtain the initial fiber optic-based data from the signal returned from the wellbore. In some aspects, the data extraction unit 402 can produce a raw fiber optic-based data set.

In some aspects, the raw data can be pre-processed using a spatial sample filter. The spatial selection uses a filter to obtain a portion of the acoustic signal corresponding to a desired depth range in the wellbore when the raw signal extends across a broader section than the desired channel selection for analysis. Since the time the light pulse sent into the optical fiber returns as backscattered light can correspond to the travel distance, and therefore depth in the wellbore, the acoustic data can be processed to obtain a sample indicative of the desired depth or depth range. This may allow a specific depth section within the wellbore to be isolated for further analysis. The pre-processing step may also include removal of spurious back reflection type noises at specific depths through spatial median filtering or spatial averaging techniques.

In some aspects, the raw fiber optic-based data set can comprise raw fiber optic-based data across a plurality of channels within the wellbore. The number of data channels can vary from well to well depending on the specific optical fiber implementation. In general, the number of channels may comprise all or a portion of the production zone of the wellbore, and/or sections such as a non-producing upper completion section. However, any or all of the resulting raw fiber optic-based data available can be output from the data extraction unit 402. In some embodiments, various optional analysis such as frequency band extraction, frequency analysis and/or transformation, intensity and/or energy calculations, and/or determination of one or more properties of the acoustic data can also be performed in the data extraction unit 402.

Various optional processing (e.g., pre-processing steps) can be performed using the processing system 404. Techniques such as noise removal, normalization, and the like can be performed on the fiber optic-based data using the processing system 404, and the data can then be passed to the output/visualization system 406 to prepare an image for further analysis.

The fiber optic-based data (e.g., the optionally pre-processed and normalized fiber optic-based data) can be used to form an image for use with an anomaly detection model using the output/visualization system 406. To produce the image, the selected fiber optic-based data (e.g., acoustic power, acoustic energy, one or more features, etc.) for the selected depth section can be prepared over a selected time interval. The image can comprise the fiber optic-based data imaged as a plot of depth relative to time. The time period can comprise any reasonable time period for viewing the potential anomalies and/or events. In some aspects, short term events such as microseismic events may occur over a time period of a fraction of a second to a few seconds. Other events such as fluid leaks may occur over a longer time period such as minutes to hours. In order to capture shorter transient events, the time period used for the generation of the image may be between about 0.1 seconds to about 2 minutes, between about 0.5 seconds to about 1 minutes, or between about 1 second to about 30 seconds (e.g., between about 10-30 seconds, etc.).

A noise normalization routine can be performed on the data (e.g., the raw fiber optic-based data, the pre-processed data, etc.) to improve the signal quality. Normalization can aid in the subsequent processing steps to avoid outliers or data values that are larger in scale from skewing the learning process or dominating the processing. This step can vary depending on the type of acquisition device used as well as the configuration of the light source, the sensor, and the other processing routines. Any suitable normalization routines can be used to process the acoustic data. For example, the fiber optic-based data can be normalized using minimum-maximum scaling, z-score normalization, decimal scaling normalization, log scaling normalization, robust normalization, or any combination thereof.

In some aspects, the data can be normalized using robust normalization. Robust normalization uses the median and interquartile range (IQR) values to normalize the data, which can adjust for outliers. In some aspects, the data values can be normalized using the formula X_{robust}=(X−median)/IQR. The robust normalization can apply to any values used to form the images used with the anomaly and/or event detection models.

Once the image is formed, the image can be further processed prior to being used with a model. In some aspects, the image can be pre-processed using an optional noise removal process. Any suitable noise removal technique can be used, and the noise removal can be used to suppress unwanted noise. Noise removal may be limited to avoid removing image features that can be identified in the various processing steps. In some aspects, various techniques such as Gaussian blurring, median filtering, bilateral filtering, wavelet denoising, and the like can be used to process the images formed by the fiber optic-based data.

In some aspects, the optional noise removal process can comprise a surface noise removal process. Surface noise removal can be used to eliminate artifacts or distortions from an image while retaining the underlying features. Surface noise can arise from environmental factors (e.g., wellbore noises, fluid flows, etc.), sensor parameters, compression artifacts, and system irregularities that can obscure the signal of interest. Any suitable surface noise removal techniques can be used. Suitable techniques can include, but are not limited to, smoothing filters, edge-preserving techniques, and/or frequency-based or frequency filtering techniques (e.g., using signals in the time or frequency domain).

The image can also be standardized, normalized, or formatted as part of the image pre-process. In some aspects, the resulting image can then be processed to format the image to a standard image size. Various techniques such as image interpolation can be used to resize, transform, or fill in missing portions of the image, and produce an image having a standardized size and resolution matching the input requirements to the model. The resulting standardized image can then be stored in the memory, transferred across a computer network, and/or provided to the anomaly detection model.

The resulting image, such as the pre-processed image based on the fiber optic base data, can be used as an input to an anomaly detection model to detect an anomaly within the image with the anomaly detection model. Any suitable model can be used. In some aspects, the anomaly detection model can comprise a deep learning model such as a neural network system or model.

In some aspects, the anomaly detection model can comprise a U-Net model which is a form of a convolutional neural network (CNN) that uses a U-shaped architecture to perform image segmentation and reconstruction. Within the U-Net model, the input image can be segmented and reconstructed to allow the input image and reconstructed images to be compared to determine a loss parameter. As described in more detail herein, the U-Net can be trained on images using background fiber optic-based data without anomalies present so that any input images having anomalies may have a loss parameter that exceeds a threshold, thereby indicating the presence of an anomaly. As used herein, an anomaly refers to any event that is not simply background noise. An anomaly may not identify or classify a particular event, but can simply indicate when something other than background noise is present. This can then be used to identify fiber optic data that can be further processed to classify an event using a classification model.

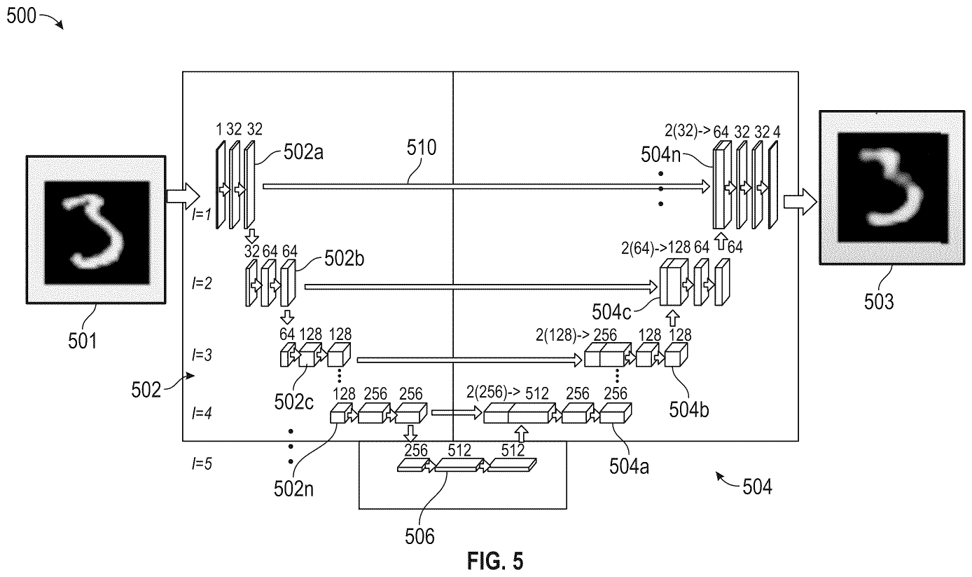

FIG. 5 illustrates an example of U-Net model architecture 500 that can be employed for the anomaly detection mode. The U-Net model 500 comprises a contracting (encoder) path 502 and an expanding (decoder) path 504. In some embodiments, the contracting path 502 can be similar to an architecture of a convolutional network, and includes repeated application of convolutions, rectified linear units (ReLU), and/or optional pooling layers. In the example shown in FIG. 5, two 3×3 convolutions (unpadded convolutions), and a rectified linear unit (ReLU) can be used. As shown, contracting path 502 comprises an input layer 502a to accept the input image 501. Contracting path 502 also comprises a plurality of downsampling layers 502b to 502n. As an example, n can equal 4, and each downsampling layer 502 b to 502 n performs a convolution (e.g., a 2D convolution) that halves the number of feature channels. Expansive path 504 comprises a plurality of upsampling layers 504a to 504n. As an example, n can equal 4 and each upsampling layer 504a to 504n performs a deconvolution (e.g., a 2D deconvolution) that doubles the number of feature channels, and where at least some of the layers 504a to 504n, such as, e.g., layers 504a to 504c, can also perform spatial dropout. Additionally, a layer 506 is included in the U-Net architecture 500, and can be said to be within each path 502 and 504 as shown. In some embodiments, each layer of path 502 can include a 2D convolution, batch normalization, and rectified linear units (ReLU). The layers of path 504 employ deconvolution (also referred to as “transposed convolution”), batch normalization, and ReLU.

Within the U-Net model, each downsampling layer 502b to 502n reduces the number of pixels by half, while increasing the number of feature channels. For example, where the input image of layer 502a is a 512×1 image slice (where 512 represents the number of pixels and 1 represents the number of channels), application of that image slice to layer 502b results in a 256×2 image slice. Application of that 256×2 image slice to layer 502c results in a 128×4 image slice, and application of the 128×4 image slice to subsequent layer 502n results in a 64×8 image slice. Similarly, application of the 64×8 image slice to layer 506 results in a 32×16 image slice. Additional layers can be incorporated to further downsample the layers to form a 1×512 image slice if needed. Of course, the foregoing values are examples only, and the scope of the invention is not limited thereto.

Each layer in the expansive path 504 upsamples the (feature map) input received thereby followed by a 2×2 convolution (“up-convolution”) that doubles the number of pixels, while reducing the number of channels. Also, a concatenation with the correspondingly cropped feature map from the contracting path is provided with convolutions, each followed by a ReLU.

In an example aspect herein, concatenations are provided by connections between corresponding layers of the paths 502 and 504, to concatenate post-convoluted channels to the layers in path 504. This feature is because, in at least some cases, when an image slice is provided through the path 504, at least some details of the image may be lost. As such, predetermined features (also referred to herein as “concatenation features”) 510 (such as, e.g., features which preferably are relatively unaffected by non-linear transforms) from each post-convolution image slice in the path 502 are provided to the corresponding layer of path 504, where the predetermined features are employed along with the image slice received from a previous layer in the path 504 to generate the corresponding expanded image slice for the applicable layer.

More particularly, in the illustrated embodiment, the 32×16 image slice obtained from layer 506, and concatenation features 510 from layer 502n, are applied to the layer 504 a, resulting in a 64×8 image slice being provided, which is then applied along with concatenation features 510 from layer 502 c to layer 504 b, resulting in a 128×4 image slice being provided. Application of that 128×4 image slice, along with concatenation features 510 from layer 502 b, to layer 504 c results in a 256×2 image slice, which is then applied along with concatenation features 510 from layer 502a to layer 504n, resulting in a 512×1 image slice being provided. In one example embodiment herein, cropping may be performed to compensate for any loss of border pixels in every convolution. The resulting 512×1 image can be taken as the output image 503 from the U-Net model and used as a comparison with the input image to determine a loss parameter.

The U-Net model can be trained using suitable training data to reduce or minimize the loss between the input image 501 and the output image 503. The data used for training can generally comprise images based on fiber optic-based output data obtained from one or more wellbores. In some aspects, the data used to train the U-Net model can comprise data without an anomaly present. The resulting data can then comprise or be representative of background noise within the wellbore. The training data can be pre-processed and formatted as described herein to provide the data for training the U-Net model. A portion of the data can be used for an supervised learning approach while a remaining portion can be used for model validation. In some aspects, between about 30% to about 90% of the available background data can be used for training, and the remaining portion can be used for validation to ensure that a desired accuracy if obtained prior to use of the model.

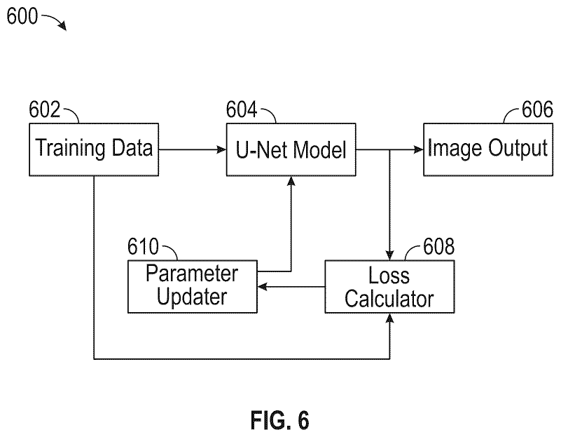

As shown in FIG. 6, a training system 600 can include the U-Net model 604 along with additional elements comprising a loss calculator 608 and a parameter updater 610. The initial U-Net model can be assumed not to be trained, and/or the starting U-Net model can be assumed to need to be updated or calibrated using new or additional training data.

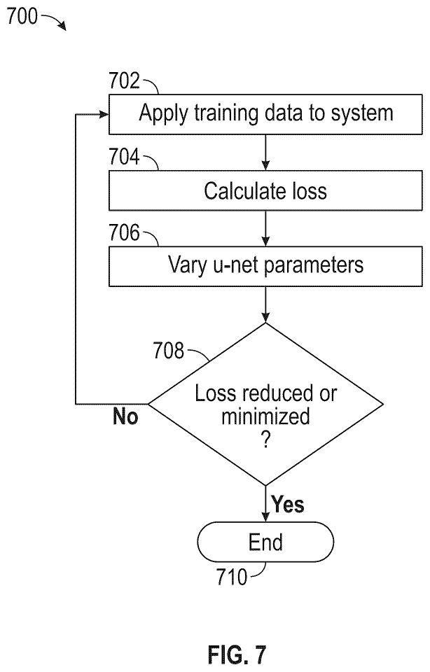

As shown in FIG. 6 and FIG. 7, the system 600 of FIG. 6 can be fed with one or more images or frames from a training data set in step 702, and the system 600 can operate as described above to downsample and upsample each image to form a reconstructed image as described above, in response to the input image (except that the U-Net architecture can be assumed not to be fully trained). For each instance of the input image(s), the system 600 can provide an output image, which can be passed to the loss calculator 608. Also, the system can pass the input image to the loss calculator 608 as a second input, which represents the original desired image. For example, in a case where it is desired to train the architecture to predict/isolate an anomaly, then the input image can be a training image representing a background fiber optic-based signal not having an anomaly present. In step 704 the loss calculator 608 can employ a loss function to determine how much difference there is between the output image and input image (e.g., the target).

Any suitable loss function can be used to determine a loss parameter, where the loss parameter can be an indication of the difference between the input and the output of the U-Net model. In some aspects, the loss function can be a the L1 loss function, the L2loss function, or any other suitable loss function. In some aspects, the loss function is the L1 loss function. The L1 loss represents a pixel-wise loss between the output image and the input image based on the mean absolute error loss function. The L1 loss can provide a value indicative of the magnitude of the differences between the input image and the reconstructed image.

The resulting loss parameter can be provided from loss calculator 608 to parameter updater 610, which, based on the result, varies one or more parameters of the U-Net architecture 604, if needed, to reduce the loss value at step 706. The process 700 can be performed again in as many iterations as needed to substantially reduce or minimize the loss parameter to an acceptable level, at which point the U-Net architecture 500 is considered to be trained. For example, in step 708 it can be determined whether the loss parameter is sufficiently minimized. If “yes” in step 708, then the method ends at step 710 and the architecture is deemed trained. If “no” in step 708, then control passes back to step 702 where the procedure 700 is performed again as many times as needed until the loss value is deemed sufficiently minimized.

The manner in which the parameter updater 610 varies the parameters of the U-Net architecture 500 in step 706 can be in accordance with any suitable technique, such as, by example and without limitation, altering one or more weights, kernels, and/or other applicable parameter values of the U-Net architecture 500, and in some aspects, can include performing a stochastic gradient descent algorithm. A portion of the training data set can be retained for validation purposes once the model is trained.

Once trained, the model can be used to detect an anomaly. In use, the fiber optic-based data can be provided to the anomaly detection model to detect an anomaly. For example, data from a measured fiber optic-based sensor can be processed and input into the U-Net model to provide an output. The input and output can be provided to the loss calculator to determine the loss parameter, such as the L1 loss. The anomaly detection model can be trained using background fiber optic data without any anomalies present. An input comprising an anomaly may then not be successfully reconstructed using the model so that a resulting loss calculation can have a detectable loss. When the loss parameter exceeds a threshold, the excess loss parameter can then be used to indicate that an anomaly is present in the input image.

Data provided to the anomaly detection model that does not result in the detection of an anomaly can optionally either be discarded or stored. For example, the ability to discard data that does not contain an anomaly can avoid the need for further processing and/or storage to save on processing and storage costs for large amounts of data that do not need to be analyzed. When an anomaly is detected, the fiber optic-based data can be received and used to update an event database. The data can also be sent to another database and/or the event database can be located remotely from the processing location. The data can then be further analyzed for event detection and/or visualization in near real time or at any later time.

The fiber optic-based data can then be used with an event detection model to identify one or more events. For example, the process of FIG. 2 can be used to identify one or more events. The fiber optic-based data can be pre-processed as described herein, or one or more additional or alternative processing steps can be used to process the fiber optic-based data. In some aspects, the data having identified anomalies can be used directly in an event detection model without further processing.

In some aspects, the fiber optic-based data can be processed using a variety of transforms to provide an image having different or additional data used in the event detection model. For example, the images used in the event detection model can comprise the raw fiber optic-based sensor output (e.g., optical power, acoustic intensity, etc.), and/or one or more fiber optic-based features can be determined from the raw fiber optic-based sensor outputs. In some aspects, the features used to form the input images can include those in the time domain, the frequency domain, various transforms (e.g., wavelets, Fourier transforms, etc.) of the raw data, and/or those derived from portions of the fiber optic based signal or other sensor inputs. Such other features can be used on their own or in combination one or more frequency domain features, including in the development of transformations of the features. In some aspects, more than one feature can be used to form the input images such that a plurality of channels are present in the input image(s) provided to the event detection model. In some aspects, one, or at least two, three, four, five, six, seven, eight, etc. different features can be used to form the image(s) used with the event detection models. While the resulting model may be more complex, the use of additional channels with the event detection model may provide an improved accuracy and/or the ability to distinguish additional events.

In some aspects, the fiber optic-based data that is used to form the image can be the same or different, and if different, can generally correlate to the fiber optic-based data. For example, a time period of the data used to generate the image may be the same as or less than the time period of the data used to form the image used with the anomaly detection model. In some aspects, the depth range of the fiber optic-based data used to form the image for the event detection model can be the same as or a subset of the fiber optic-based data used to form the image for the anomaly detection model.

The input images to the event detection model can be the same or different than the fiber optic-based image used with the anomaly detection model. In some aspects, the fiber optic-based data can be pre-processed and/or normalized using the same or different techniques. Further, the specific features used, and the number of features used, to form the image can be the same or different than that used to form the image used with the anomaly detection model. In some aspects, the number of features used to form the image for the event detection model can be greater than the number of features used to form the image used in the anomaly detection model.

Once processed, the fiber optic data, such as the pre-processed fiber optic base data, can be used as an input to an event detection model to detect one or more events within the sample data set with the event detection model. Any suitable model can be used. In some aspects, the event detection model can comprise a deep learning model such as a neural network system or model. In some aspects, the event detection model can comprise a convolutional neural network (CNN) that can be used for image classification. The classifications can represent different events, including any of those described herein. For example, the event detection model can be used to identify events including, but not limited to, wellbore integrity events, tubing or casing leaks, flow behind casing, microseismic events, wellbore operating events (e.g., sleeve movements, choke movements, choke ramp-ups, etc.), gas influx, fluid flow past restrictions, seismic shots, slug movements, and/or sand ingress. In some aspects, other events such as a defined background event can be used to see if the input image contains background noise. Other events or event classes can also be identified such as a weak anomaly event, a strong anomaly event, or the like. Thus, use of larger classifications can help to identify classes of events to help align the results with more detailed event identifications.

In some aspects, the event detection model can comprise a residual network model (e.g., a ResNet CNN model), which is a form of a CNN that can be used for classification or segmentation of images based on deep learning. A ResNet is a deep neural network having a convolutional structure, and is a deep learning architecture. As a deep learning architecture, the CNN is a feed-forward artificial neural network. Neurons in the feed-forward artificial neural network may respond to an input image based on the fiber optic based data into the feed-forward artificial neural network.

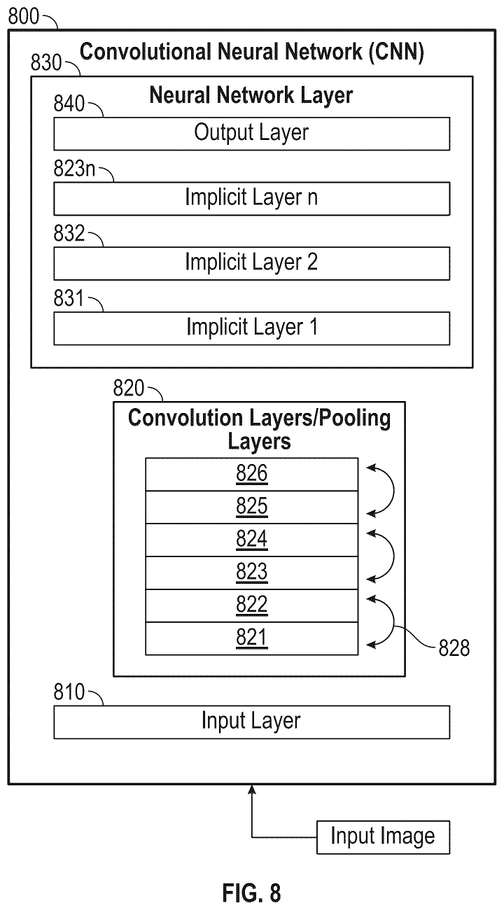

As shown in FIG. 8, a convolutional neural network (CNN) 800 such as a ResNet model may include an input layer 810, convolution layers/pooling layers 820 (where the pooling layers are optional), a plurality of residual blocks, fully connected layers (e.g., a neural network layer 830), and an output layer 840. A ResNet can differ from a conventional CNN through the incorporation of the residual blocks, each of which includes a shortcut (e.g., a skip 828) connection that can bypass one or more intermediate convolutional layers.

The convolution layers/pooling layers 820 may include layers 821 to 826, as an example. For example, in some aspects, layer 821 can be a convolution layer, layer 822 can be a pooling layer, layer 823 can be a convolution layer, layer 824 can be a pooling layer, layer 825 can be a convolution layer, and layer 826 can be a pooling layer. In some aspects, layers 821 and 822 can be convolution layers, layer 823 can be a pooling layer, layers 824 and 825 can be convolution layers, and layer 826 can be a pooling layer. More generally, an output of a convolution layer may be used as an input of a following pooling layer, or may be used as an input of another convolution layer to continue to perform convolution.

As an overview, a convolution layer 821 may include many convolution filters. A convolution filter can also be referred to as a convolution kernel. During image processing, the convolution kernel can be equivalent to a filter that extracts specific information from an input image matrix. The convolution kernel may be a predefined weight matrix. In a process of performing convolution on an image, depending on a value of a stride, the weight matrix usually processes one pixel after another pixel or two pixels after another two pixels in an input image along a horizontal direction, so as to complete a task of extracting a specific feature from the image. A size of the weight matrix should be related to a size of the image. It should be noted that a depth dimension of the weight matrix can be the same as a depth dimension of the input image. During a convolution operation, the weight matrix extends to an entire depth of the input image. The depth dimension is also a channel dimension, and is corresponding to a quantity of channels. Therefore, one convolutional output with a single depth dimension is generated after convolution is performed by using a single weight matrix. However, in most cases, a plurality of weight matrices with a same size (rows×columns) can be applied instead of a single weight matrix. Outputs of the weight matrices are stacked to form a depth dimension of a convolutional image. Different weight matrices may be used to extract different features of an image. For example, a weight matrix can be used to extract edge information of the image, another weight matrix can be used to extract a specific color or pixel value of the image, and still another weight matrix is used to blur unnecessary noise in the image. The plurality of weight matrices has the same size (rows×columns). Feature graphs extracted by using the plurality of weight matrices with the same size can also have a same size. Then the plurality of extracted feature graphs with the same size are combined to form a convolution operation output.

In application, weighted values in the weight matrices need to be obtained through massive training. Weight matrices formed by weighted values obtained through training may be used to extract information from an input image, so that the CNN 800 performs correct prediction. A weight matrix is a convolution kernel, and a weighted value in the weight matrix can be a parameter in the convolution kernel. The parameter in the convolution kernel may also be referred to as an element in the convolution kernel.

When the CNN 800 has a plurality of convolution layers, an initial convolution layer (for example, 821) usually extracts a relatively large quantity of general features. The general feature may also be referred to as a low-level feature. As the depth of the convolutional neural network 800 increases, a feature extracted by a subsequent convolution layer (for example, 826) becomes more complex, for example, a feature including a high-level semantic meaning. A feature with a higher-level semantic meaning is more applicable to a to-be-resolved problem.

A quantity of training parameters usually needs to be reduced. Therefore, pooling layers can be used periodically after convolution layers. In the layers 821 to 826, one convolution layer may be followed by one pooling layer, or a plurality of convolution layers may be followed by one or more pooling layers. During image processing, the purpose of a pooling layer is to reduce a space size of an image. The pooling layer may be used to perform an average pooling operation and/or a maximum pooling operation, so as to perform sampling on an input image to obtain a smaller-size image. The average pooling operation may be used to perform calculation on pixel values in the image in a specific range, to generate an average value. The average value is used as an average pooling result. The maximum pooling operation may be used to take a maximum pixel value in the specific range as a maximum pooling result. In addition, a size of a weight matrix at a convolution layer can be related to an image size, and similarly, an operator at a pooling layer should also be related to an image size. A size of an output image obtained through processing at a pooling layer may be smaller than a size of an input image of the pooling layer. Each pixel in the output image of the pooling layer represents an average value or a maximum value of a corresponding sub-region of the input image of the pooling layer.

The residual connections (e.g., skip 828) are the building unit of the ResNet. Each residual connection 828 can receive an input tensor, processes it through a series of convolutional, batch normalization, and activation layers, and combine the processed output with the original input tensor via an additive shortcut connection. Shortcut connections facilitate the propagation of gradient signals directly through the network by allowing information to bypass non-linear transformations. These connections are implemented as identity mappings or, in cases of dimensional mismatch, linear projections using 1×1 convolutions. The inclusion of residual blocks addresses the degradation problem by ensuring that layers learn incremental transformations rather than complete mappings. This can result in a more complex CNN while facilitating the training of CNNs with hundreds or even thousands of layers.

Processing performed at the convolution layers/pooling layers 820 can result in feature extraction, and a reduction in the parameters resulting from an input image. In order to generate a class or other related information, the convolutional neural network 800 can generate, by using the neural network layer 830, one output or a group of outputs whose quantity is equal to a quantity of required classes. To do so, the neural network layer 830 may include a plurality of implicit layers (for example, layers 831, 832, . . . , and 823n shown in FIG. 8) and an output layer 840. Parameters included in the plurality of implicit layers may be obtained by performing pre-training based on related training data of specific task types. For example, the task types may include event recognition and/or event classification.

The output layer 840 is formed after the plurality of implicit layers in the neural network layer 830. The output layer 840 can have a loss function, including any of those described herein. In some aspects, the loss function can be a classification cross entropy loss function. The loss function can be used to calculate a predicted error. Once forward propagation (for example, in FIG. 8, propagation in a direction from 810 to 840 is the forward propagation) of the entire convolutional neural network 800 is completed, weighted values and offsets of the aforementioned layers can be updated in backpropagation (for example, in FIG. 8, propagation in a direction from 840 to 810 is the backpropagation), so as to reduce a loss of the convolutional neural network 800 and an error between an ideal result and a result (namely, the foregoing image processing result) output by the convolutional neural network 800 by using the output layer.

The ResNet CNN 800 can be trained using a labeled data set. Various sources of data such as historical optical fiber-based data can be used to generate images associated with known events. The events can be identified using various techniques such as data taken during induced events (e.g., fluid injection, fracturing operations, etc.), events identified using other techniques or models, or data generated in a test setup such as a fluid flow loop in which the event conditions can be controlled and generated for the purposes of recording optical fiber data.

The training data can be pre-processed using any of the techniques described herein to process the optical fiber event data. The pre-processing should match between the training data and the event data used in practice in terms of normalization, scaling, noise removal, and the like.

During training, the weights in the ResNet CNN can be initialized using any suitable technique. The skip connections in the residual blocks can be configured for the proper identity mappings and projection layers. A loss function can then be defined, and can include the loss function associated with the output layer 840. Any suitable loss function can be used such as a cross-entropy loss, which can be used for classification tasks such as event classifications, and/or mean squared error loss functions used for regression tasks. Other loss functions as described herein can also be used in some aspects.

During training the labeled data can be used as inputs to the ResNet CNN model in a forward pass process, and the resulting loss function can be used to calculate a difference in the model outputs and the true labels associated with the training data. Training algorithms such as stochastic gradient descent (SGD) can be used to update the model weights and parameters to reduce the loss function using backpropagation. Many iterations across the training data set can be used to properly fit the weights and parameters to produce a trained ResNet CNN model. A portion of the training data can be used for validation to prevent overfitting to the specific training data. Once trained, the ResNet CNN model can be used for event identification as the event detection model.

As described above, the trained event detection model can be used to receive an image and identify (e.g., classify, etc.) an event associated with the image. When the event detection model is a CNN (e.g., a ResNet CNN model, etc.), the output can indicate a classification. The classifications can represent the various events for which the event detection model is trained. Any of the events described herein can be used in the training and identification of the events using the event detection model.

The image data used for the event detection model can be pre-processed, denoised, and otherwise prepared as described above. The resulting image can then be passed to the event detection model. The resulting output of the event detection model can then identify the event and/or event class. The identification process can be repeated using subsequent fiber optic-based samples to provide a continuous identification of an event. For example, a continuous sampling of the data using relatively short time frame samples ranging from about 10 seconds to about 10 minutes, can provide an indication of a start of an event as well as an end of an event. For example, if fluid flow is detected over three event detection image each having a sample length of 5 minutes, then the fluid inflow can be identified in the wellbore over a 15 minute period.

In general, the event can be identified within the image provided to the event detection model. This can result in an identification of the event over the depth range and time frame represented by the image. In some aspects, a subset of the image can be processed to provide an event identification with the subset of the depth and/or time represented by image subset. The process can be repeated to provide an identification of a specific event or event class over a predetermined time frame. In some aspects, the processing can occur in real time or near real time.

In some aspects, various actions can be taken based on the identification of the events within the wellbore. In some embodiments, the event identification process can be performed, and based on the specific identification of the events, the wellbore may be reconfigured to address the event(s). For example, the identification of sand ingress may allow the production rate to be reduced using a choke or sleeve. The presence of fluid slugging can be addressed by adjusting the production rate from one or more zones within the wellbore. The detection of a leak can be addressed by performing a remediation process to seal the leak. Any other suitable actions can be taken within the wellbore and/or at surface processing equipment to address the events once detected.

The data obtained during the anomaly detection and event detection processes can be stored using various processes. In some aspects, only the data in which an anomaly is detected may be stored. This can allow large amounts of data without any anomalies to be discarded, thereby saving storage costs. When an anomaly is detected, the data can be stored to allow the event detection model to be used to detect the event. The data that is stored can be stored in and used to update an event database. The data can also be sent to another database and/or the event database can be located remotely from the processing location. The stored data can then be further analyzed and visualized in near real time or at any later time.

In some aspects, the data that is stored can comprise the images used as inputs to the anomaly detection model and/or the event detection model, and any suitable image compression techniques can be used to store the images. This type of storage can be used to reduce the amount of data stored relative to raw fiber optic data set. Thus, the process disclosed herein advantageously reduces the amount of raw fiber optic data such as raw acoustic data obtained from the wellbore to produce a useful and manageable representation of the anomalies and events.

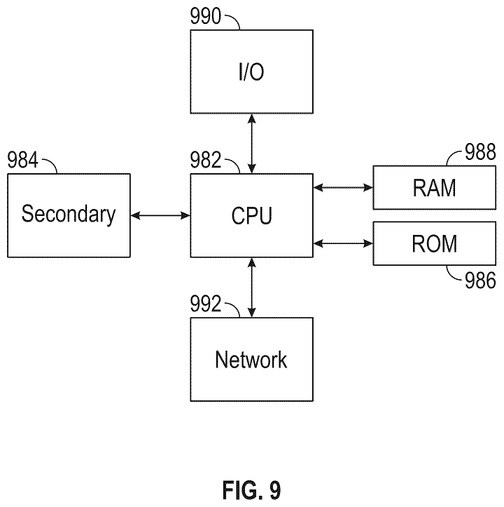

Any of the systems and methods disclosed herein can be carried out on a computer or other device comprising a processor, such as the acquisition device 160 of FIG. 1. FIG. 9 illustrates a computer system 980 suitable for implementing one or more embodiments disclosed herein. The computer system 980 includes a processor 982 (which may be referred to as a central processor unit or CPU) that is in communication with memory devices including secondary storage 984, read only memory (ROM) 986, random access memory (RAM) 988, input/output (I/O) devices 990, and network connectivity devices 992. The processor 982 may be implemented as one or more CPU chips.

It is understood that by programming and/or loading executable instructions onto the computer system 980, at least one of the CPU 982, the RAM 988, and the ROM 986 are changed, transforming the computer system 980 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 980 is turned on or booted, the CPU 982 may execute a computer program or application. For example, the CPU 982 may execute software or firmware stored in the ROM 986 or stored in the RAM 988. In some cases, on boot and/or when the application is initiated, the CPU 982 may copy the application or portions of the application from the secondary storage 984 to the RAM 988 or to memory space within the CPU 982 itself, and the CPU 982 may then execute instructions that the application is comprised of. In some cases, the CPU 982 may copy the application or portions of the application from memory accessed via the network connectivity devices 992 or via the I/O devices 990 to the RAM 988 or to memory space within the CPU 982, and the CPU 982 may then execute instructions that the application is comprised of. During execution, an application may load instructions into the CPU 982, for example load some of the instructions of the application into a cache of the CPU 982. In some contexts, an application that is executed may be said to configure the CPU 982 to do something, e.g., to configure the CPU 982 to perform the function or functions promoted by the subject application. When the CPU 982 is configured in this way by the application, the CPU 982 becomes a specific purpose computer or a specific purpose machine.

The secondary storage 984 is typically comprised of one or more disk drives or tape drives and is used for non-volatile storage of data and as an over-flow data storage device if RAM 988 is not large enough to hold all working data. Secondary storage 984 may be used to store programs which are loaded into RAM 988 when such programs are selected for execution. The ROM 986 is used to store instructions and perhaps data which are read during program execution. ROM 986 is a non-volatile memory device which typically has a small memory capacity relative to the larger memory capacity of secondary storage 984. The RAM 988 is used to store volatile data and perhaps to store instructions. Access to both ROM 986 and RAM 988 is typically faster than to secondary storage 984. The secondary storage 984, the RAM 988, and/or the ROM 986 may be referred to in some contexts as computer readable storage media and/or non-transitory computer readable media.

I/O devices 990 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 992 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 992 may enable the processor 982 to communicate with the Internet or one or more intranets. With such a network connection, it is contemplated that the processor 982 might receive information from the network, or might output information to the network (e.g., to an event database) in the course of performing the above-described method steps. Such information, which is often represented as a sequence of instructions to be executed using processor 982, may be received from and outputted to the network, for example, in the form of a computer data signal embodied in a carrier wave.

Such information, which may include data or instructions to be executed using processor 982 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 982 executes instructions, codes, computer programs, scripts which it accesses from hard disk, floppy disk, optical disk (these various disk based systems may all be considered secondary storage 984), flash drive, ROM 986, RAM 988, or the network connectivity devices 992. While only one processor 982 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 984, for example, hard drives, floppy disks, optical disks, and/or other device, the ROM 986, and/or the RAM 988 may be referred to in some contexts as non-transitory instructions and/or non-transitory information.

In an embodiment, the computer system 980 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 980 to provide the functionality of a number of servers that is not directly bound to the number of computers in the computer system 980. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 980, at least portions of the contents of the computer program product to the secondary storage 984, to the ROM 986, to the RAM 988, and/or to other non-volatile memory and volatile memory of the computer system 980. The processor 982 may process the executable instructions and/or data structures in part by directly accessing the computer program product, for example by reading from a CD-ROM disk inserted into a disk drive peripheral of the computer system 980. Alternatively, the processor 982 may process the executable instructions and/or data structures by remotely accessing the computer program product, for example by downloading the executable instructions and/or data structures from a remote server through the network connectivity devices 992. The computer program product may comprise instructions that promote the loading and/or copying of data, data structures, files, and/or executable instructions to the secondary storage 984, to the ROM 986, to the RAM 988, and/or to other non-volatile memory and volatile memory of the computer system 980.

In some contexts, the secondary storage 984, the ROM 986, and the RAM 988 may be referred to as a non-transitory computer readable medium or a computer readable storage media. A dynamic RAM embodiment of the RAM 988, likewise, may be referred to as a non-transitory computer readable medium in that while the dynamic RAM receives electrical power and is operated in accordance with its design, for example during a period of time during which the computer system 980 is turned on and operational, the dynamic RAM stores information that is written to it. Similarly, the processor 982 may comprise an internal RAM, an internal ROM, a cache memory, and/or other internal non-transitory storage blocks, sections, or components that may be referred to in some contexts as non-transitory computer readable media or computer readable storage media.

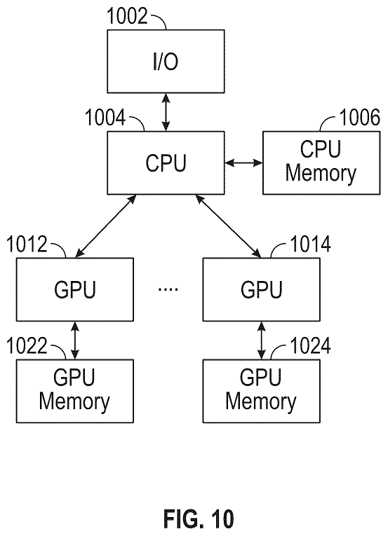

FIG. 10 illustrates an exemplary architecture in which a plurality of graphics processing units (GPUs) 1012-1014 can be communicatively coupled to one or more processors 1004 (which can be the same or similar to the CPU 982) over any suitable link (e.g., buses, point-to-point interconnects, etc.). The use of GPUs may be used to train and/or execute the various models described herein, including the anomaly detection model and/or event detection model. While two GPUs are shown, any number of GPUs can be present and communicatively coupled. The GPUs 1012-1014 can be interconnected over high-speed links, which may be implemented using same or different protocols/links than those used for connections between the CPU 1004 and the GPUs 1012-1014.

The CPU 1004 can be communicatively coupled to a processor memory 1006, via memory interconnects, and each GPU 1012-1014 can be communicatively coupled to GPU memory 1022-1024, respectively, over GPU memory interconnects. The memory interconnects may use the same or different memory access technologies. For example, processor memory 1006 and GPU memories 1022-1024 can be any of the memories discussed with respect to FIG. 9, including volatile memories such as dynamic random access memories (DRAMs) (including stacked DRAMs), Graphics DDR SDRAM (GDDR) (e.g., GDDR5, GDDR6), or High Bandwidth Memory (HBM) and/or may be non-volatile memories. In some embodiments, some portion of processor memories may be volatile memory and another portion may be non-volatile memory.

The CPU(s) 1004 may include various components for receiving instructions from interface 1002, executing instructions, controlling the GPUs, and processing data. The CPU 1004 can be used to provide information such as training data and model control parameters (e.g., loss functions, etc.) to the GPUs, which can operate to the train and run the models. Depending on the complexity of the models and amount of training data, any suitable number of CPUs and GPUs can be present to train the models in a desired amount of time.

Having described various systems and methods herein, specific embodiments can include, but are not limited to:

In a first aspect, a method of detecting an event within a wellbore comprises: obtaining a sample data set, wherein the sample data set is a sample of fiber optic-based signal originating within a wellbore, and wherein the sample data set is representative of the fiber optic-based signal across a depth section of the wellbore over a time period; forming an image using the fiber optic-based signal; using the image as an input to an anomaly detection model; detecting an anomaly within the image with the anomaly detection model; and outputting an indication of the anomaly.

A second aspect can include the method of the first aspect, further comprising: saving the sample data set with the indication of the anomaly.

A third aspect can include the method of the first or second aspect, wherein the sample data set is obtained from a fiber optic based distributed acoustic sensing (DAS) sensor.

A fourth aspect can include the method of any one of the first to third aspects, wherein the anomaly detection model comprises a deep-learning algorithm.

A fifth aspect can include the method of the fourth aspect, wherein the deep-learning algorithm comprises a U-Net neural network.

A sixth aspect can include the method of any one of the first to fifth aspects, further comprising: pre-processing the image prior to using the image as the input to the anomaly detection model.

A seventh aspect can include the method of the sixth aspect, 7wherein pre-processing the sample data set comprises: normalizing the sample data set using robust normalization.

An eighth aspect can include the method of any one of the first to seventh aspects, wherein detecting the anomaly comprises: supplying the image to a U-Net neural network system; converting the image to an output image; comparing the output image to the image; determining a loss parameter based on the comparing of the output image to the image; determining that the loss parameter exceeds a threshold; and detecting the anomaly based on the loss parameter exceeding the threshold.

A ninth aspect can include the method of any one of the first to eighth aspects, further comprising: forming a second image from the sample data set; applying the second image to an event detection model; detecting an event in the second image using the event detection model; and outputting an indication of the event.

A tenth aspect can include the method of the ninth aspect, wherein the event detection model comprises a convolutional neural network (CNN) model.

An eleventh aspect can include the method of the ninth or tenth aspect, wherein the event detection model comprises a ResNet neural network system.

A twelfth aspect can include the method of any one of the ninth to eleventh aspects, wherein the image and the second image are the same.

A thirteenth aspect can include the method of any one of the ninth to twelfth aspects, wherein the event comprises a wellbore integrity event, a tubing or casing leak, flow behind casing, a microseismic event, a wellbore operating event, gas influx, fluid flow past a restriction, a seismic shot, a slug movement, sand ingress, a weak anomaly event, a strong anomaly event, or any combination thereof.

A fourteenth aspect can include the method of any one of the first to thirteenth aspects, wherein the image comprises depth versus time data representative of acoustic power, acoustic intensity, a feature derived from the frequency domain, a feature derived from the time domain, any derivation thereof, or any combination thereof.

In a fifteenth aspect, a system for detecting an event within a wellbore comprises a processor; and a memory storing a plurality of models, that when executed on the processor, configures the processor to: obtain a sample data set from a fiber optic sensor, wherein the sample data set is a sample of fiber optic-based signal originating within a wellbore, and wherein the sample data set is representative of the fiber optic-based signal across a depth section of the wellbore over a time period; form an image using the fiber optic-based signal; use the image as an input to an anomaly detection model; detect an anomaly within the image with the anomaly detection model; and output an indication of the anomaly to a display device.

A sixteenth aspect can include the system of the fifteenth aspect, wherein the processor is further configured to: save the sample data set with the indication of the anomaly.

A seventeenth aspect can include the system of the fifteenth or sixteenth aspect, wherein the sample data set is obtained from a fiber optic based distributed acoustic sensing (DAS) sensor.

An eighteenth aspect can include the system of any one of the fifteenth to seventeenth aspects, wherein the anomaly detection model comprises a deep-learning algorithm.

A nineteenth aspect can include the system of the eighteenth aspect, wherein the deep-learning algorithm comprises a U-Net neural network.

A twentieth aspect can include the system of any one of the fifteenth to nineteenth aspects, wherein the processor is further configured to: pre-process the image prior to using the image as the input to the anomaly detection model.

A twenty first aspect can include the system of the twentieth aspect, wherein the processor is configured to pre-process the sample data set using robust normalization.

A twenty second aspect can include the system of any one of the fifteenth to twenty first aspects, wherein the processor is further configured to: apply the image to a U-Net neural network system; convert the image to an output image; compare the output image to the image; determine a loss parameter based on the comparing of the output image to the image; determine that the loss parameter exceeds a threshold; and detect the anomaly based on the loss parameter exceeding the threshold.

A twenty third aspect can include the system of any one of the fifteenth to twenty second aspects, wherein the processor is further configured to: form a second image from the sample data set; apply the second image to an event detection model; detect an event in the second image using the event detection model; and output an indication of the event.

A twenty fourth aspect can include the system of the twenty third aspect, wherein the event detection model comprises a convolutional neural network (CNN) model.

A twenty fifth aspect can include the system of the twenty third or twenty fourth aspect, wherein the event detection model comprises a ResNet neural network system.

A twenty sixth aspect can include the system of any one of the twenty third to twenty fifth aspects, wherein the image and the second image are the same.

A twenty seventh aspect can include the system of any one of the twenty third to twenty sixth aspects, wherein the event comprises a wellbore integrity event, a tubing or casing leak, flow behind casing, a microseismic event, a wellbore operating event, gas influx, fluid flow past a restriction, a seismic shot, a slug movement, sand ingress, a weak anomaly event, a strong anomaly event, or any combination thereof.

A twenty eighth aspect can include the system of any one of the fifteenth to twenty seventh aspects, wherein the image comprises depth versus time data representative of acoustic power, acoustic intensity, a feature derived from the frequency domain, a feature derived from the time domain, any derivation thereof, or any combination thereof.

In a twenty ninth aspect, a method of detecting an event within a wellbore comprises: obtaining a sample data set from a fiber optic sensor disposed in a wellbore, wherein the sample data set is a sample of fiber optic-based signal, and wherein the sample data set is representative of the fiber optic-based signal across a depth section of the wellbore over a time period; forming an image using the fiber optic-based signal; using the image as an input to an anomaly detection model, wherein the anomaly detection model comprises a deep-learning algorithm; detecting an anomaly within the image with the anomaly detection model; forming a second image from the sample data set; applying the second image to an event detection model, wherein the event detection model comprises a convolutional neural network (CNN); detecting an event in the second image using the event detection model; and outputting an indication of the event.

A thirtieth aspect can include the method of the twenty ninth aspect, wherein the sample data set is obtained from a fiber optic based distributed acoustic sensing (DAS) sensor.

A thirty first aspect can include the method of the twenty ninth or thirtieth aspect, wherein the deep-learning algorithm comprises a U-Net neural network.

A thirty second aspect can include the method of any one of the twenty ninth to thirty first aspects, further comprising: pre-processing the image prior to using the image as the input to the anomaly detection model.

A thirty third aspect can include the method of the thirty second aspect, wherein pre-processing the sample data set comprises: normalizing the sample data set using robust normalization.

A thirty fourth aspect can include the method of any one of the twenty ninth to thirty third aspects, wherein detecting the anomaly comprises: applying the image to a U-Net neural network system; converting the image to an output image; comparing the output image to the image; determining a loss parameter based on the comparing of the output image to the image; determining that the loss parameter exceeds a threshold; and detecting the anomaly based on the loss parameter exceeding the threshold.

A thirty fifth aspect can include the method of any one of the twenty ninth to thirty fourth aspects, wherein the event detection model comprises a ResNet neural network system.

A thirty sixth aspect can include the method of any one of the twenty ninth to thirty fifth aspects, wherein the image and the second image are the same.

A thirty seventh aspect can include the method of any one of the twenty ninth to thirty sixth aspects, wherein the event comprises a wellbore integrity event, a tubing or casing leak, flow behind casing, a microseismic event, a wellbore operating event, gas influx, fluid flow past a restriction, a seismic shot, a slug movement, sand ingress, a weak anomaly event, a strong anomaly event, or any combination thereof.

A thirty eighth aspect can include the method of any one of the twenty ninth to thirty seventh aspects, wherein the image comprises depth versus time data representative of acoustic power, acoustic intensity, a feature derived from the frequency domain, a feature derived from the time domain, any derivation thereof, or any combination thereof.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. For example, features described as method steps may have corresponding elements in the system embodiments described above, and vice versa. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of detecting an event within a wellbore, the method comprising:
obtaining a sample data set, wherein the sample data set is a sample of fiber optic-based signal originating within a wellbore, and wherein the sample data set is representative of the fiber optic-based signal across a depth section of the wellbore over a time period;
forming an image using the fiber optic-based signal;
using the image as an input to an anomaly detection model;
detecting an anomaly within the image with the anomaly detection model; and
outputting an indication of the anomaly.

2. The method of claim 1, further comprising:
saving the sample data set with the indication of the anomaly.

3. The method of claim 1, wherein the sample data set is obtained from a fiber optic based distributed acoustic sensing (DAS) sensor.

4. The method of claim 1, wherein the anomaly detection model comprises a deep-learning algorithm.

5. The method of claim 4, wherein the deep-learning algorithm comprises a U-Net neural network.

6. The method of claim 1, further comprising:
pre-processing the image prior to using the image as the input to the anomaly detection model.

7. The method of claim 6, wherein pre-processing the sample data set comprises:
normalizing the sample data set using robust normalization.

8. The method of claim 1, wherein detecting the anomaly comprises:
supplying the image to a U-Net neural network system;
converting the image to an output image;
comparing the output image to the image;
determining a loss parameter based on the comparing of the output image to the image;
determining that the loss parameter exceeds a threshold; and
detecting the anomaly based on the loss parameter exceeding the threshold.

9. The method of claim 1, further comprising:
forming a second image from the sample data set;
applying the second image to an event detection model;
detecting an event in the second image using the event detection model; and
outputting an indication of the event.

10. The method of claim 9, wherein the event detection model comprises a convolutional neural network (CNN) model.

11. The method of claim 9, wherein the event detection model comprises a ResNet neural network system.

12. The method of claim 9, wherein the image and the second image are the same.

13. The method of claim 9, wherein the event comprises a wellbore integrity event, a tubing or casing leak, flow behind casing, a microseismic event, a wellbore operating event, gas influx, fluid flow past a restriction, a seismic shot, a slug movement, sand ingress, a weak anomaly event, a strong anomaly event, or any combination thereof.

14. The method of claim 1, wherein the image comprises depth versus time data representative of acoustic power, acoustic intensity, a feature derived from the frequency domain, a feature derived from the time domain, any derivation thereof, or any combination thereof.

15. A system for detecting an event within a wellbore, the system comprising:
a processor; and
a memory storing a plurality of models, that when executed on the processor, configures the processor to:
obtain a sample data set from a fiber optic sensor, wherein the sample data set is a sample of fiber optic-based signal originating within a wellbore, and wherein the sample data set is representative of the fiber optic-based signal across a depth section of the wellbore over a time period;
form an image using the fiber optic-based signal;
use the image as an input to an anomaly detection model;
detect an anomaly within the image with the anomaly detection model; and
output an indication of the anomaly to a display device.

16. The system of claim 15, wherein the processor is further configured to:
save the sample data set with the indication of the anomaly.

17. The system of claim 15, wherein the sample data set is obtained from a fiber optic based distributed acoustic sensing (DAS) sensor.

18. The system of claim 15, wherein the anomaly detection model comprises a deep-learning algorithm.

19. The system of claim 18, wherein the deep-learning algorithm comprises a U-Net neural network.

20. The system of claim 15, wherein the processor is further configured to:
pre-process the image prior to using the image as the input to the anomaly detection model.

21. The system of claim 20, wherein the processor is configured to pre-process the sample data set using robust normalization.

22. The system of claim 15, wherein the processor is further configured to:
apply the image to a U-Net neural network system;
convert the image to an output image;
compare the output image to the image;
determine a loss parameter based on the comparing of the output image to the image;
determine that the loss parameter exceeds a threshold; and
detect the anomaly based on the loss parameter exceeding the threshold.

23. The system of claim 15, wherein the processor is further configured to:
form a second image from the sample data set;
apply the second image to an event detection model;
detect an event in the second image using the event detection model; and
output an indication of the event.

24. The system of claim 23, wherein the event detection model comprises a convolutional neural network (CNN) model.

25. The system of claim 23, wherein the event detection model comprises a ResNet neural network system.

26. The system of claim 23, wherein the image and the second image are the same.

27. The system of claim 23, wherein the event comprises a wellbore integrity event, a tubing or casing leak, flow behind casing, a microseismic event, a wellbore operating event, gas influx, fluid flow past a restriction, a seismic shot, a slug movement, sand ingress, a weak anomaly event, a strong anomaly event, or any combination thereof.

28. The system of claim 15, wherein the image comprises depth versus time data representative of acoustic power, acoustic intensity, a feature derived from the frequency domain, a feature derived from the time domain, any derivation thereof, or any combination thereof.

29. A method of detecting an event within a wellbore, the method comprising:
obtaining a sample data set from a fiber optic sensor disposed in a wellbore, wherein the sample data set is a sample of fiber optic-based signal, and wherein the sample data set is representative of the fiber optic-based signal across a depth section of the wellbore over a time period;
forming an image using the fiber optic-based signal;
using the image as an input to an anomaly detection model, wherein the anomaly detection model comprises a deep-learning algorithm;
detecting an anomaly within the image with the anomaly detection model;
forming a second image from the sample data set;
applying the second image to an event detection model, wherein the event detection model comprises a convolutional neural network (CNN);
detecting an event in the second image using the event detection model; and
outputting an indication of the event.

30. The method of claim 29, wherein the sample data set is obtained from a fiber optic based distributed acoustic sensing (DAS) sensor.

31. The method of claim 29, wherein the deep-learning algorithm comprises a U-Net neural network.

32. The method of claim 29, further comprising:
pre-processing the image prior to using the image as the input to the anomaly detection model.

33. The method of claim 32, wherein pre-processing the sample data set comprises:
normalizing the sample data set using robust normalization.

34. The method of claim 29, wherein detecting the anomaly comprises:
applying the image to a U-Net neural network system;
converting the image to an output image;
comparing the output image to the image;
determining a loss parameter based on the comparing of the output image to the image;
determining that the loss parameter exceeds a threshold; and
detecting the anomaly based on the loss parameter exceeding the threshold.

35. The method of claim 29, wherein the event detection model comprises a ResNet neural network system.

36. The method of claim 29, wherein the image and the second image are the same.

37. The method of claim 29, wherein the event comprises a wellbore integrity event, a tubing or casing leak, flow behind casing, a microseismic event, a wellbore operating event, gas influx, fluid flow past a restriction, a seismic shot, a slug movement, sand ingress, a weak anomaly event, a strong anomaly event, or any combination thereof.

38. The method of claim 29, wherein the image comprises depth versus time data representative of acoustic power, acoustic intensity, a feature derived from the frequency domain, a feature derived from the time domain, any derivation thereof, or any combination thereof.
